(19) United States
(12) Patent Application Publication
(10) Pub. No.: US 2015/0355760 A1
(43) Pub. Date: Dec. 10, 2015

(54) MULTI-MODAL SYSTEM AND METHOD TO IMPROVE HUMAN MEMORY USING A VIDEO GAME

(71) Applicant: The Regents of the University of California, Oakland, CA (US)

(72) Inventors: Aaron Seitz, Riverside, CA (US); Victor Zordan, Riverside, CA (US)

(73) Assignee: The Regents of the University of California, Oakland, CA (US)

(21) Appl. No.: 14/732,213

(22) Filed: Jun. 5, 2015

Related U.S. Application Data
(60) Provisional application No. 62/008,122, filed on Jun. 5, 2014.

(51) Int. Cl. G06F 3/048

(52) U.S. Cl. CPC G06F 3/048

(57) ABSTRACT

A multi-modal system to improve human memory using a video game comprises a multi-modal criteria having a task object for the video game and stimulus sets. There is also provided a multi-modal method to improve human memory using a video game by providing a video game comprising multi-modal criteria, having a task object for the video game, and having stimulus sets.

### CROSS-REFERENCE TO RELATED APPLICATIONS

This application claims the benefit of U.S. Provisional Patent Application No. 62/008,122, filed Jun. 5, 2014, entitled “Multi-Modal Method To Improve Human Memory Using a Video Game”, the full contents of which are hereby incorporated by reference.

### FIELD OF THE INVENTION

The present invention relates to methods for memory improvement in humans, and more specifically to a multi-modal method to improve human memory using a video game.

### BACKGROUND

Mental fitness, despite its critical value for the success and well-being of individuals and the larger society, has received less systematic attention than physical fitness. Unlike physical training, there exists no universally accepted scientific methodology to systematically promote mental fitness in either cognitively impaired or normally functioning individuals. For example, as long as scientists have explored memory, our ability to combine knowledge from past experience together with incoming information from the environment to perform effectively in the world, they have strived, and often failed, to improve it.

Recently, advancements in cognitive science and video game technologies offer promise to achieve procedures that will improve memory. Modern computing technologies have led to enormous innovations in entertainment software and hardware, and are poised to have transformative impact on cognitive health. Cognitive Neuroscience has advanced the understanding of the neural systems underlying memory processes, including plasticity within these systems, and has refined behavioral procedures that engage these functions. Commercial video games have become ubiquitous, sophisticated, and shaped by competitive market pressures to become both perceptually engaging (rich graphics, sounds, and animations.) and cognitively challenging. Combining these elements of computing, cognitive science, and video game design can lead to behavioral cognitive therapies that are effective, encourage compliance by being compelling, stimulating and fun.

While there exists a new generation of brain training games—cognitive training integrated with entertainment software—that have potential for the improvement of impaired and normal memory function, surrounding research is still very much in its infancy. To date, two general approaches have been explored: 1) Studying incidental benefits of off-the-shelf games; 2) Turning standard cognitive tasks (e.g., N-Back for memory, go-nogo or flanker tasks for attention and executive processing, etc.) into training “games” in a process denoted “gamifying.” Quantitative efficacy has been reported in ADHD, Chemo Brain, Age-Related Cognitive Decline, Dyslexia, Schizophrenia, Sensory Deficits, Brain Injury, etc, and for general mental fitness4. However, the benefits of existing games remain controversial, with broad claims based on limited, and at times irrelevant, scientific evidence; off-the-shelf games (understandably) optimized for gaming experience, not mental fitness, and gamified versions of cognitive tasks often failing to generalize beyond the training environment.

Gamified versions of laboratory cognitive tasks fail to provide significant benefits outside their narrow training environment, while off-the-shelf games exhibit unguided improvements in select areas. These modern approaches demonstrate promise but are limited in a number of ways.

Research demonstrates that objects that are simultaneously represented by multiple modalities are better remembered and that coordinated training with multiple modalities better supports sensory representations of those stimuli. However, to date memory training approaches, such as, Lumos Labs, Posit Science, CogMed, and N-back tasks, use stimuli from either a singular sensory modality (color, sound, location, shape, etc.) and with a singular task-modality (memory-updating, spatial memory, memory capacity), or an uncoordinated combination of these approaches wherein two or more tasks are conducted simultaneously or in sequence. The disadvantage of the standard approach is that they fail to exercise memory processes in a multi-modal manner and thus do not transfer well to real-world memory contexts.

Therefore there is a need for a multi-modal method to improve human memory using a video game.

### SUMMARY OF THE INVENTION

According to a preferred embodiment, a method for improving human memory using a video game, the method comprises the steps of: providing a video game comprising task objects defining multi-modal criteria, the multi-modal criteria comprising one or more stimulus sets; playing the stimulus sets; and recording results of the playing of the stimulus sets.

According to another preferred embodiment, a system for improving human memory using a video game comprises: at least one processor; a set of instructions executable on the processor comprising a video game, the video game comprising task objects defining multi-modal criteria, the multi-modal criteria comprising one or more stimulus sets; and a database for recording the results playing of the stimulus sets.

### BRIEF DESCRIPTION OF THE DRAWINGS

These and other features, aspects and advantages of the present invention will become better understood with regard to the following description, appended claims, and accompanying figures wherein:

FIG. 1 is a diagrammatic representation of an exemplary internet-based environment in which one embodiment may operate;

FIG. 2 is a diagrammatic representation of the components of one or more of the portable or stationary user devices according to the embodiment of FIG. 1;

FIG. 3 is a diagrammatic representation of the components of a server device according to the embodiment of FIG. 1;

FIG. 4 is a diagrammatic representation of the server device of FIGS. 1 and 3, and a storage device with a database containing electronic data that is transformed;

FIG. 5 is a diagram of a multi-modal system to improve human memory using a video game, according to one embodiment;

FIG. 6 is a diagram of multimodality defined across multiple dimensions; and

FIG. 7 is a flow diagram illustrating steps performed by the game engine software during game play according to the embodiment of FIGS. 1-6.

### DETAILED DESCRIPTION

The present invention overcomes the limitations of the prior art by providing a multi-modal method to improve human memory using a video game. It accomplishes this by improving memory through coordinated multi-modal methods. Both memory storage and retrieval involves multiple senses. For example, the smell of a loved one's perfume (olfaction) can invoke memories of their face (vision), and so on. However, existing memory tasks that employ multiple (stimulus) modalities use these in competition, which research shows doesn't promote learning, and may in fact interfere with it. The presented system and method takes a different approach and define objects through multi-modal feature sets. The strength of incorporating multisensory objects into memory training is that each sense can boost learning in the other. For example, an individual with limited visual capabilities will benefit from training utilizing concordant auditory stimuli. Along this line, research demonstrates that objects that are simultaneously represented by multiple modalities are better remembered and that coordinated training with multiple modalities better supports sensory representations of those stimuli.

Beyond multisensory stimuli, our invention includes the power of coordinated modalities across training, including brain training modes (e.g., spatial vs. sequential) and game modes which require diverse actions of the player. The common goal of these efforts is to promote generalization across exercises, ultimately improving benefits outside the training setting itself, i.e., in transference to real-world memory contexts. The intuition behind the approach builds upon the observation that memory in natural contexts is informed by coordinated inputs from multiple modalities and that integrated memory processes typically involve interactions with such stimuli under different conditions.

A case example is the “n-back” task; a working memory updating exercise requiring participants to memorize and constantly update the serial positions “n steps back” in a continuous stimulus stream. The basic task is to report when the current stimulus (for example, a color) matches the stimulus n-items back in a sequence. Conducting this task with different n's increases working memory capacity and encourages mental flexibility. N-back training reportedly produces increased working-memory capacity in healthy populations, anatomical changes in memory related cortical structures, cognitive improvements in cognitively impaired children and Schizophrenia, and shows transfer to fluid intelligence, attention, verbal and visual declarative memory and processing speed. While n-back training is highly promising, its generalization and transfer to cognitive domains is debated and failures to replicate transfer effects call into question which aspects of this notoriously complex task promote learning. Extant n-back tasks use a single category of auditory (e.g. tones or letter names) and/or visual stimuli (spatial grid location, color or object) and all of the existing n-back tasks that employ multiple stimulus modalities use these in competition, which we have shown doesn't promote learning, and may in fact interfere with it.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure wherein the element first appears.

As used in this disclosure, except wherein the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, wherein the interface is the point of interaction with software, or computer hardware, or with peripheral devices.

Various embodiments provide a multi-modal method to improve human memory using a video game. The method will now be disclosed in detail.

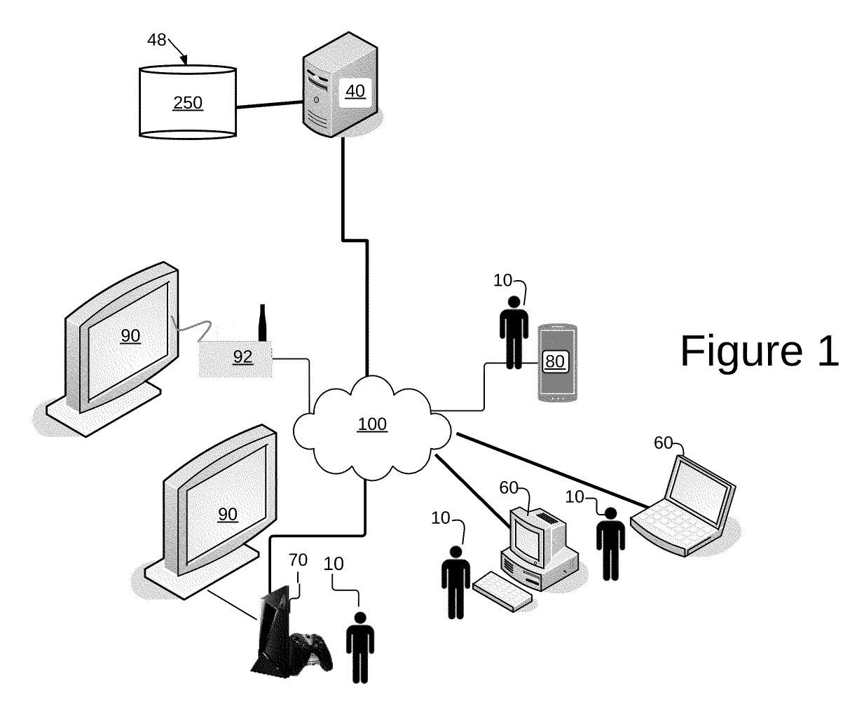

With reference to FIG. 1, a diagrammatic representation of an exemplary internet-based system is shown in which the system and method may operate according to one embodiment. As is typical on today's internet 100, users 10 may connect to and use the internet 100 over several platforms. Those platforms may include personal computers 60, mobile phones or tablets 80, or the like. One of the latest ways to connect to the internet includes using internet protocol television, or IPTV, boxes 92. These IPTV boxes 92 include a wireless or wired device that has a memory and storage for applications or apps that connects to the internet 100. Through an IPTV box 92, users may use the apps contained therein to display videos, pictures, and internet sites on a television (TV) 90. The television is typically connected to the IPTV box 92 via an HDMI cord, component cable, or audio/video (A/V) input lines.

Over and above the mobile phones and tablets 80, computers 60, and the like, discussed above, other popular devices, such as modern game consoles 70, are now capable of video play. Game consoles 70 such as the XBOX®, Playstation®, Nintendo®, Wii®, and others, provide for internet video presentation. Just as with the IPTV box 92, game consoles 70 typically connect to a TV 90 on which videos may be viewed and games played.

One or more servers 40 may include one or more storage devices 48 containing one or more databases 250.

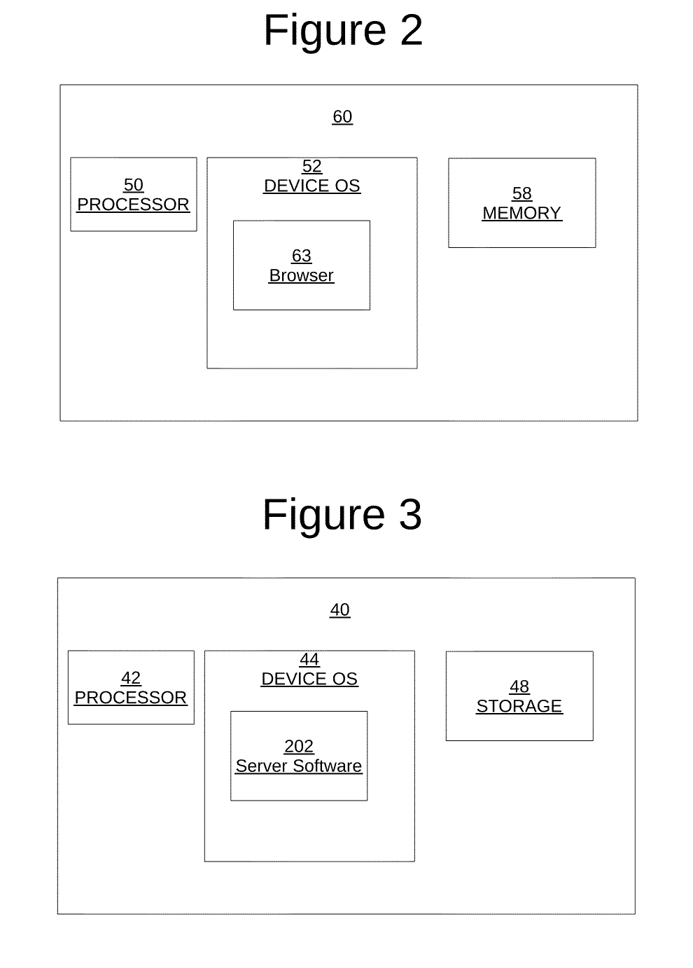

With reference to FIG. 2, a diagrammatic representation of the internal components of one or more of the user devices 60 (92, 70, 80 in FIG. 1) is shown. As those skilled in the art would recognize, each user device 60, 92, 70, 80 may include a processor 50 and operating system 52, on which executable instructions of a browser app 63 may execute. As those skilled in the art would recognize, the browser app 63. Further, the user devices 60, 92, 70, 80 may each have a random access memory (RAM) 58 that may be used for running browser app 63, loading programs, and storing program variable data.

With reference to FIG. 3, a diagrammatic representation of the internal components of the server device 40 of FIG. 1 is shown. As those skilled in the art would recognize, the server device 40 may include a processor 42 and server operating system 44, on which executable instructions of a game engine software 202 may execute. As those skilled in the art would recognize, the computer program, which may embody game engine software 202, may be loaded by an operating system 44 for running on the server 40.

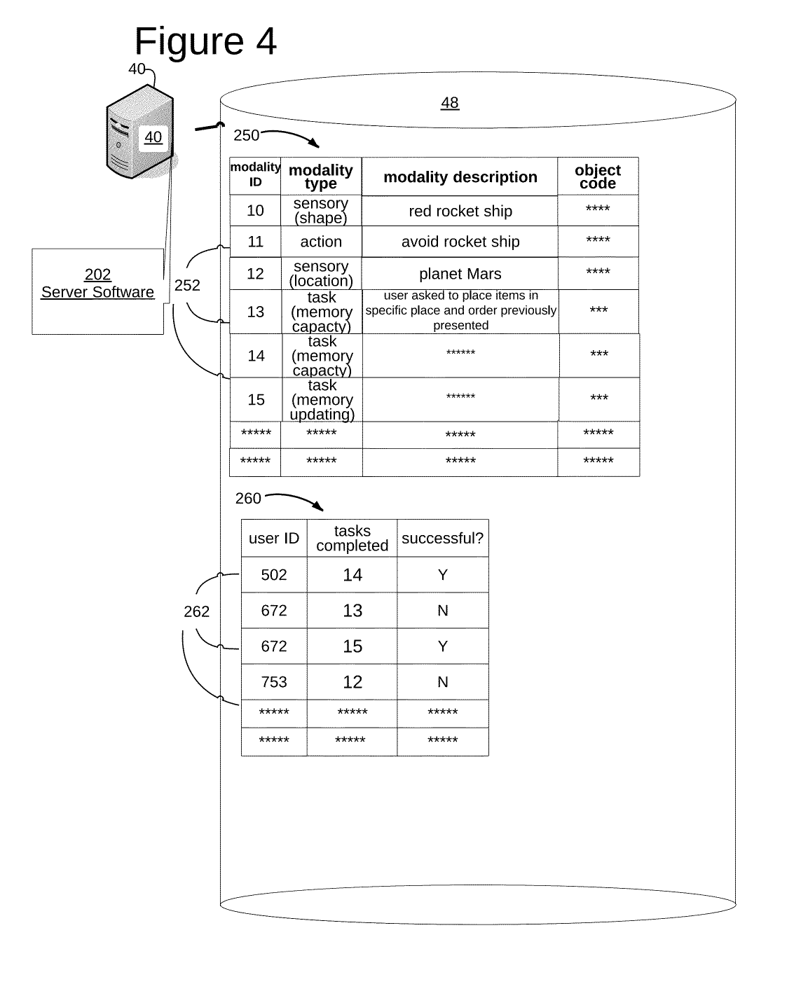

With reference to FIG. 4, a diagrammatic representation of the one or more servers 40, and a storage device 48, is shown. As indicated above, the server 40 may have executing within it game engine software 202. The game engine software 202 may comprise instructions to run online games played by users 10. The storage device 48 may store one or more databases to play of the online games. An exemplary database table 250 is shown in FIG. 4 illustrating some of the electronic data that may be stored and transformed to manage game play. For example, each record 252 of table 250 may contain content assets for game play described below. Each record 252 may contain a field for modality identifier (ID), a field for the type of modality, and a description field. Further, an executable object code field may contain the object code or link libraries to execute each module that the game engine software may call upon to execute during game play.

Another table 260 may contain user data. For example, records in table 262 may contain user play data, including fields for the user identifier (ID), game tasks completed, and whether each task the user played was successful or unsuccessful.

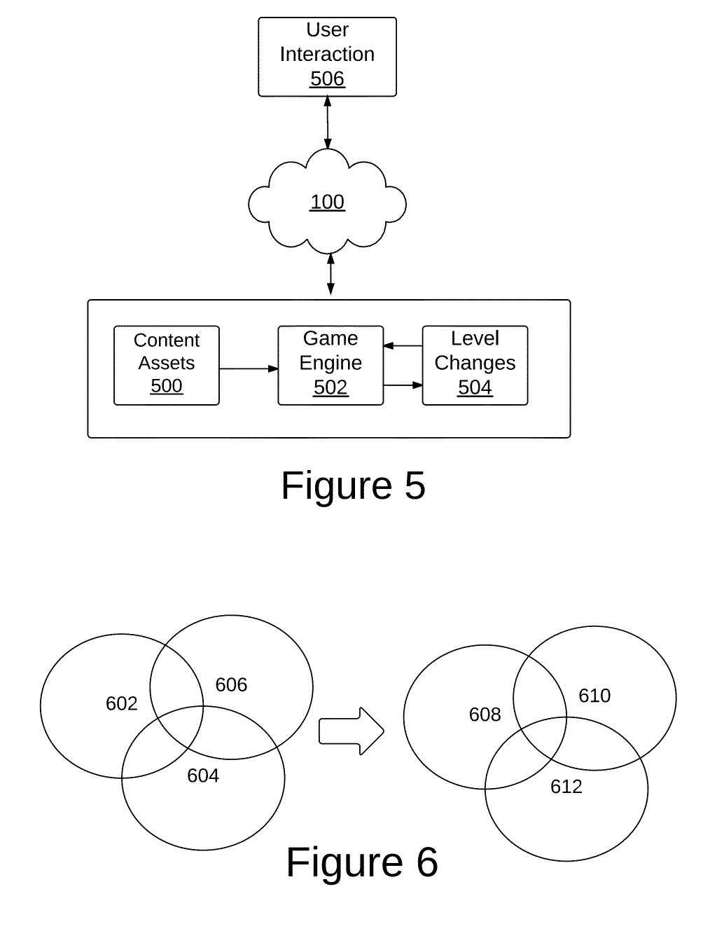

Referring now to FIG. 5, there is shown a flow diagram for multi-modal embodiment to improve human memory executed by the game engine software 202, according to one embodiment. The game engine software 202 comprises modules for reading content assets, step 500, for operating the game engine 202, step 502, to run level changes 504 and provide user interface for interaction, step 506 through the network 100. The system may incorporate engaging video game design as an aspect of bridging the gap between commercial games and cognitive training. The practices of good video game design are becoming better understood and documented. As the field matures, design rules and constraints are refined and accepted. For example, games establish clear goals and allow players to realize those goals through meaningful actions. In one embodiment, aspects that make games run the game engine 202 engaging include mechanics, interaction, and the like. These aspects may include, by way of example, and not by way of limitation:
1) Game Mechanics: the core rules of games that dictate how players enact change to achieve the necessary steps to progress, make or break games by acting as the foundation for gameplay. Mechanics are the main tool for building a desirable, fun activity for users. If they are faulty, little can be done to make a player enjoy their game-playing experience.
2) Interaction: the hardware and software elements between players and games, enables players to engage, interact and communicate. Good interaction often is intuitive and builds upon players' prior experience to facilitate meaning and action, and provides feedback conveying undeniable evidence that players' actions are understood.
3) Visual/Sensory Experience: an important aspect of any game, as aesthetics have a profound impact on the engagement of the audience. Players enjoy interacting with pleasing and/or provocative sensory experience. A rich and engaging environment for the game, including its soundscape, is a key factor that determines whether players will continue to play, or to find something else to do.
4) Progression of games: temper the challenges to meet players' changing skill levels. Progression, often in the form of game levels, may be a key to ensure games are cast within the range of player skills. As players become more proficient in achieving established goals, game difficulty should increase to maintain interest. Progression plays a particularly key role in our framework. Its influence is two-fold, both to keep engagement, promoting treatment compliance, but also to grow appropriately as to promote maximal benefit in to mental fitness.

The system incorporates these principles to produce very different brain games than those seen to date. For example, the status quo to gamify n-back tasks is to add a skin, such as frogs on lily pads that make the test look like a game without fundamental change to the basic task. Such games are at best mildly entertaining, however, and lack the qualities that make commercial games successful user experiences. For example in an n-back game of the present system, the player may be expected to discern during a collection task wherein n-back is the rubric for success. The player controls the position of a basic character in an intuitive fashion and the playful task is set in a simple but enticing environment with whimsical sounds and colors. The player controls, the environment's complexity, as well as the level of the n-back itself increasing challenge as the game unfolds. The system adheres to game development principles while playing memory challenges that utilize expert knowledge of cognitive processes.

The system may be used for mental fitness and mental well-being, including memory improvement, in a wide array of applications including the healthy pre-emptive training of healthy individuals and the improvement of mentally disabled and mentally impaired and sub-optimal conditions, including but not limited to PTSD, alcohol and drug abuse recovery, ADHC, Parkinson's disease, and mental decline of all forms such as elderly and aging.

Referring now to FIG. 6, there is shown a diagram of multimodality defined across multiple dimensions using in the game engine software 202. The multimodality method takes a fundamentally different approach wherein task-objects are defined together by their look and sound. The system supports multimodal and amodal memory representations and facilitates unisensory ones, to promote generalization across tasks and stimulus sets, signals with a broad set of visual (colors, locations, textures, shapes, faces, etc.) and auditory (e.g., tones, letters, voices, environmental sounds) dimensions are employed using both abstract and real-world stimuli. Furthermore, the method, using n-back tasks, exercises a small subset of working-memory processes, and to promote broader generalization our approach is to couple it with coordinated tasks exercising spatial memory, with associations between objects. The system also uses flexibility of order and perspective of memory access further to add to the multimodal aspects of the training. In total, the system acknowledges the positive impact of training with tasks, such as, for example, the n-back tasks, and uses the tasks as one of many building blocks of a larger context designed to broadly impact memory.

The system improves memory using a video game that exercises memory function through the coordination of information across modalities either simultaneously or in sequence to meet this goal. The system uses training participants using custom video games that are designed to make memory tasks fun to use and challenging to participants as their memory skills develop. The advantage of the video game is that it engages cognitive processes while entertaining participants, and simultaneously improves compliance and training. The method builds upon the observation that memory in natural contexts is informed by coordinated inputs from multiple modalities (for example, colors, shapes, textures, sounds, scents, feel, taste, etc.) and that memory processes typically involve sequential interactions with such stimuli and under different conditions. The method trains participants in memory tasks wherein stimuli are defined by multiple features (for example, color and shape, sound and color, shape and color, shape color and sound, etc.) and/or engaging users with these under multiple different contexts (for example, memory updating tasks, memory capacity tasks, object recognition and search tasks, etc.) so as to better exercise memory processes as they are engaged typical real-world contexts.

The method for improving memory uses video games that specifically exercise memory through the coordination of multiple modalities. In this context, the modalities are defined broadly to include (but not to be limited to) the following forms:

1) Sensory modalities 602—signal/stimuli to be defined by sensory features such as (but not limited to) color, texture, shape, faces, location, context, movement, sound, music, haptics, etc.

2) Action or response modalities 604—within the game, actions convey player, these include (but are not limited to) grab, target, move, jump, avoid, etc.

3) Task modalities 606—the brain training may be coordinated across tasks including (but not limited to) memory updating, spatial memory testing, memory capacity, memory association as well as short term and long term memory testing, etc.

For example, the method can employ: multi-modal stimuli, visual 608, auditory 610 and haptic 612—defined by multiple features, such as color (visual stimuli 608) plus shape, sound plus color, shape plus color, shape plus color and sound, texture plus motion and location, etc.; combinations of modalities as features for targets with other features as distractors; and/or tasks that engage users under multiple different contexts (for example, memory updating tasks, memory capacity tasks, spatial memory, memory association, object recognition and search tasks, etc.) To date, memory training methods have used a singular (sensory/action/task) modality training method. The system employs modalities in a coordinated manner within a memory game. The game engine 202 may employ memory training through the excitement of such modalities appearing in contemplated, purposeful pairings of two or more modalities, either appearing simultaneously or in series.

Further, the brain-training game engine 202 includes training participants using a video game that is designed to make the memory tasks fun to use and challenging to participants as their memory skills develop. The advantage of using the video game is that it engages cognitive processes while entertaining participants, which simultaneously improves both compliance and training.

It should be noted that the specific embodiments disclosed herein are meant to be exemplary and not limiting. Other repetition-based cognitive training using stimuli with multiple stimulus sets can be used alone and in combination as will be understood by those with skill in the art with reference to this disclosure. Through the participant's responses, the participant's response to the method modifies some aspect of the stimuli. Method elements are repeated in an iterative manner to the end of improving the participant's ability to process information. In another embodiment, training using a variety of exercises, even in a coordinated manner, is contemplated.

### Memory Updating

The game engine software 202 may comprise a memory updating n-back task wherein each task-item is defined by a plurality of modalities loaded from database 250 (FIG. 4). For example, the tasks loaded from database 250 can be shape and sound, color and sound, shape and color and sound, texture and sound, motion type and sound, or in any combination of features (color, texture, shape, faces, location, context, movement, sound, haptics, etc.). The task-items are defined by a collection of features, and any subset of the features can be presented during encoding and any other subset of these features (including the original set) at time of recall. The tasks can be presented in the game where the task-items can be, for example, fuel pods for a ship, petals a bee can pollinate or other tasks where the items the player responds to are defined by the player having seen the same items n-back in a previous series of items. For example, in a 2-back the response the player would match the same item that was 2 items back in the current sequence. For example, using a color stimulus of red, then green, then red, the player would have to match the second red item. Game play can be adaptive so that as the player performance increase at a given n-back, the value of n can change, and other game elements will be augmented, such as, for example, speed, navigational challenge, etc.

### Memory Capacity

The game engine software 202 may also load from database 250 a memory capacity task. Each task-item can be defined by a plurality of modalities loaded from database 250. For example, the tasks can be shapes and sounds, color and sounds, shapes and colors and sounds, textures and sounds, motion types and sounds, or any combination of features. The features can be selected from the group consisting of color, texture, shape, faces, location, context, movement, sound, and haptics. The task-items can be defined by a collection of features. Any subset of the features can be presented at the time of encoding. Any other subset of these features, including the original feature set, can be presented at the time of recall. The task can be presented in a game where the task-items can be aliens, for example, that need to be moved to a specified place, candies that need to be sorted, etc. First, the player observes a series of items and then has to respond to the series of items. The player may need to order and/or locate the items presented after the player has observed the items. For example, the items can be a series of objects of color and sound that the player must remember and sort the items into bins associated with each color-sound combination. Optionally, the player can respond to objects based on an order of presentation. The order of presentation can be a reverse order of presentation or some other predefined order. In another embodiment, some items can remain in a location originally presented to the player. In other embodiments, the items can move so that the player must track or memorize the items movements and/or relative locations of the items memorized. Game play can be adaptive so that as player performance increases, the number of items that need to be memorized will be increased, and other game elements can be augmented. For example, the length of the presentation of defining features can be decreased, spatial and temporal transformation between appearance and recall can be increased, the difficulty of selecting or placing objects in a correct location can be increased.

### Memory Updating+Capacity

Players can play a game that comprises a mixture of Memory Updating and Capacity training. For example, after playing one or more rounds of Updating training, the player can then play one or more rounds of capacity training, or vice-versa. By playing a memory updating task and a memory capacity task more memory processes can be exercised.

### Memory Updating+Capacity+Coordinated Stimuli

Players can also play a game that comprises a mixture of Memory Updating and Memory Capacity with coordinated stimuli. For example, after playing one or more rounds of Memory Updating the player can then play one or more rounds of Memory Capacity or vice-versa. However, patterns that the player learned in each exercise type can then be presented in other exercises to reinforce that pattern. The stimuli in the Memory Updating and the Memory Capacity can be unimodal and the multimodality can be seen by the player as a pattern in both the Memory Updating and the Memory Capacity that are two different task modalities. For example, in the Memory Capacity the player can experience a red then blue and then a green and then another blue item and be required to sort the items, in order, into a bin. Then in the Memory Updating the player can be presented with the same items from the Memory Capacity, in the same order, but the last blue would be the object of an n-back task. This way the same pattern can be used by the same task. Memory Updating can also be a temporal pattern task rather than an n-back task. In this case of a Memory Capacity task, a pattern can be learned, such as, a square, a pyramid, a line, a square, or a circle, and then the task target is the last item in the learned pattern. Also, a spatial pattern of items can be learned and then the player may then respond to these items in another task where the player must search for the spatial pattern of items to achieve a game objective.

### Game Play and Transformations of Electronic Documents and Data

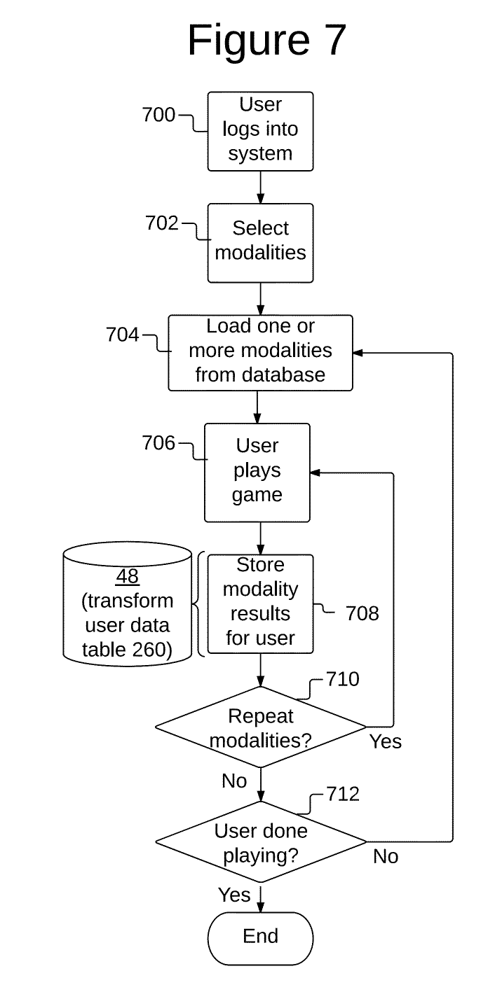

With reference to FIG. 7, a flow diagram illustrating steps performed by the game engine software 202 during game play is shown according to one embodiment. In step 700, the user 10 logs into the online game system using one of the devices 60, 92, 70, 80. In step 702, either the game engine software 202 or the user, may choose one or more modalities to play. This may include, for example, the user selecting on-screen the type of memory task. Alternatively, the game engine software 202 may select a modality based on the user's history, or by random if the user has no history. Once a modality is selected, the game engine software 202 may load the modality object code from the database 250, step 704. Game play is then executed, step 706.

Continuing to step 708, as each modality completes, the game engine software 202 may store the user results in records 262 in database 260. In step 710, either the game software 202, or the user, may have the option to repeat one or more of the modalities just played. If so, processing may move back to step 706, in which the same modality or modalities may be repeated with or without loading new modalities from database 250. If not then, in step 712, if the user does not complete game play or log out, then processing may move back to step 706 where new modalities may be selected for game play.

Thus, the electronic data or documents are transformed in database 260 to track success or failure of the user 10. The game engine software 202 may then consider such success and failures in selecting modalities in further game play to enhance the user's memory performance.

What has been described is a new and improved system and method for a multi-modal method to improve human memory using a video game, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations wherein at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. §112.

What is claimed is:

1. A method for improving human memory using a video game, the method comprising the steps of:
a) providing a video game comprising task objects defining multi-modal criteria, the multi-modal criteria comprising one or more stimulus sets;
b) playing the stimulus sets; and
c) recording results of the playing of the stimulus sets.

2. The method of claim 2, wherein the multi-modal criteria comprise:
a) a sensory modality;
b) an action modality; and
c) a task modality.

3. The method of claim 2, wherein the video game comprises a plurality of modalities.

4. The method of claim 2, wherein the multi-modal criteria is an n-back task.

5. The method of claim 4, wherein the n-back task is coupled to coordinated tasks exercising spatial memory, with associations between objects.

6. The method of claim 1, wherein the object task comprises a look and a sound to support multi-modal and amodal memory representations to facilitate unisensory representations.

7. The method of claim 1, wherein the stimulus sets can comprise abstract stimuli, real-world stimuli, and both abstract stimuli and real-world stimuli.

8. The method claim 1, further comprising selecting one or more of the stimulus sets form a database for playing.

9. The method of claim 8, wherein the step of selecting depends from the recorded results of a previous play of the stimulus sets.

10. A system for improving human memory using a video game, the system comprising:
a) at least one processor; and
b) a set of instructions executable on the processor comprising a video game, the video game comprising task objects defining multi-modal criteria, the multi-modal criteria comprising one or more stimulus sets; and
c) a database for recording the results playing of the stimulus sets.

11. The system of claim 10, wherein the multi-modal criteria comprises:
a) a sensory modality;
b) an action modality; and
c) a task modality.

12. The system of claim 11, wherein the video game comprises instructions to display a plurality of modalities.

13. The system of claim 11, wherein the task modality criteria are an n-back task.

14. The system of claim 13, wherein the n-back task is operably coupled to coordinated tasks instructions for exercising spatial memory, with associations between objects.

15. The system of claim 10, wherein the instructions for the object task comprise instructions for look and sound to support multi-modal and amodal memory representations to facilitate unisensory representations.

16. The system of claim 10, wherein the stimulus set comprise abstract stimuli, real-world stimuli, and both abstract stimuli and real-world stimuli.

17. The system of claim 10, wherein the stimulus sets are selected from a database.

18. The system of claim 17, wherein the stimulus sets are selected based on the recorded results of a previous play of the stimulus sets.
